(19) United States
(12) Patent Application Publication
(10) Pub. No.: US 2013/0016703 A1
(43) Pub. Date: Jan. 17, 2013

(54) User Identifier Multiplexing By Time Division

(71) Applicant: Jukka Tapio Ranta, Kaarina (FI)

(72) Inventor: Jukka Tapio Ranta, Kaarina (FI)

(73) Assignee: Renesas Mobile Corporation

(21) Appl. No.: 13/179,619

(22) Filed: Jul. 11, 2011

(51) Int. Cl. H04J 3/00; H04W 92/00

(52) U.S. Cl. 370/336

(57) ABSTRACT

A network assigns to a first user equipment UE and to a second UE a same temporary identifier for use at least while the first and the second UEs are simultaneously in a connected state in a same cell. Individual control channel transmissions utilizing the temporary identifier are selectively associated to only one of the first and the second UEs according to a predetermined time domain division. In various embodiments the time domain division comprises discontinuous reception DRX periods having mutually exclusive reception time periods; or mutually exclusive radio frame or subframe groups assigned to the first and second UEs for at least downlink control channel transmissions. Such radio frame/subframe groups may be even and odd numbered, or may be given by any of various example formulas if there are two or more UEs sharing the same temporary identifier. For an LTE system such an identifier may be the C-RNTI.

### TECHNICAL FIELD

The exemplary and non-limiting embodiments of this invention relate generally to wireless communication systems, methods, devices and computer programs, and more specifically relate to allocating a same identifier to multiple user equipments in a cell.

### BACKGROUND

The following abbreviations used in the specification and/or the drawings are defined as follows:
3GPP third generation partnership project
ACK acknowledgement
C-RNTI cell radio network temporary identifier
DL downlink (network towards UE)
DL-CCH downlink control channel
DL-SCH downlink shared channel
DRX discontinuous reception
eNodeB base station of a LTE/LTE-A system
E-UTRAN evolved universal terrestrial radio access network (LTE)
HARQ hybrid automatic repeat request
LTE long term evolution (of the E-UTRAN system)
MAC medium access control
MME mobility management entity
NACK negative acknowledgement
PDCCH physical downlink control channel
S-GW serving gateway
RRC radio resource control
UE user equipment
UL uplink (UE towards network)
UL-CCH uplink control channel
UL-SCH uplink shared channel

In the E-UTRAN system as well as many other radio access technologies, users are assigned a temporary identifier for use while in a cell. As smartphones and other portable interne appliances which enable mobile email, navigation and browsing have become more commonplace, many cells manage a radio environment in which there are a high number of concurrent users transferring relatively small amounts of data. Adding to this number of low volume users are smartphones which have applications such as social networking services running in the background that routinely set up a wireless connection to exchange data even without active user input.

In the LTE system such devices are in the RRC-CONNECTED state with the network access node in the cell, which assigns or otherwise allocates a C-RNTI to each mobile device as its temporary identifier. Since these C-RNTIs are used to distinguish one device in the cell from all others, each C-RNTI uniquely identifies the devices operating in the cell. Much research has gone into increasing the sheer data capacity of such radio systems but in the above scenario a limit of unique C-RNTIs available in the cell is often reached before any limit on data throughput. It is altogether possible that a newly entering device can potentially be denied connection in a cell for lack of any C-RNTIs available to allocate to it.

Embodiments of these teachings mitigate the above problem.

### SUMMARY

In a first exemplary embodiment of the invention there is an apparatus comprising a processing system comprising at least one processor, and a memory storing a set of computer instructions. In this exemplary embodiment the processing system is arranged to: assign to a first user equipment and to a second user equipment a same temporary identifier for use at least while the first and the second user equipments are simultaneously in a connected state in a same cell; and selectively associate individual control channel transmissions utilizing the temporary identifier to only one of the first and the second user equipments according to a predetermined time domain division.

In a second exemplary embodiment of the invention there is a method comprising: assigning to a first user equipment and to a second user equipment a same temporary identifier for use at least while the first and the second user equipments are simultaneously in a connected state in a same cell; and selectively associating individual control channel transmissions utilizing the temporary identifier to only one of the first and the second user equipments according to a predetermined time domain division.

In a third exemplary embodiment of the invention there is a computer readable memory storing a computer program, in which the computer program comprises: code for assigning to a first user equipment and to a second user equipment a same temporary identifier for use at least while the first and the second user equipments are simultaneously in a connected state in a same cell; and code for selectively associating individual control channel transmissions utilizing the temporary identifier to only one of the first and the second user equipments according to a predetermined time domain division.

These and other embodiments and aspects are detailed below with particularity.

### BRIEF DESCRIPTION OF THE DRAWINGS

FIG. 1 is a timing diagram showing interrelationships among transmissions on different downlink logical channels as context for exemplary embodiments of these teachings.

FIG. 2 is similar to FIG. 1 but for uplink logical channels.

FIG. 3 is a logic flow diagram that illustrates the operation of a method, and a result of execution of computer program instructions embodied on a computer readable memory, in accordance with the exemplary embodiments of this invention.

FIG. 4 is a simplified block diagram of various network devices and a UE similar to those shown at FIG. 1, which are exemplary electronic devices suitable for use in practicing the exemplary embodiments of the invention.

### DETAILED DESCRIPTION

While the exemplary embodiments of the invention detailed below are in the context of the C-RNTI which is used in the LTE system, these are simply examples and not limiting to the broader teachings herein. Various other systems use differently named temporary identifiers to distinguish mobile user devices operating in the cell and these teachings can be used to extend the number of users that a fixed number of such temporary identifiers can service. Such other systems are not limited to only cellular-type systems but also apply for wireless local area networks and other non-cellular radio access technologies.

One possible way to solve the C-RNTI limitation detailed above in the background section is to increase the number of C-RNTIs available in a cell. A similar approach was done in the past to increase the possible number of globally unique identifiers associated with the network access nodes themselves. In the past hexadecimal digits replaced previous base-10 digits to increase the number but also the number of bits allocated for a given identifier can also be used to allow for expanding the number of identifiers. This is seen as a bit difficult to implement since legacy equipment is often unable to be adapted by a simple software download to the newer system and also the old and new numbering system must be able to exist side by side for some transition period.

These teachings take a different approach to resolve or at least mitigate the problem, namely by re-using the same temporary identifier value for two or more user devices (more generally UEs) in the cell and distinguish them from one another in the time domain, such as by radio frame or subframe numbers.

As a brief overview, assume a first and a second UE are each allocated the same C-RNTI #x. Both of those UEs are in a RRC-CONNECTED state with the same cell at the same time. When the network sends control signaling such as a radio resource allocation schedule PDCCH to the first UE it will send it in a radio frame or subframe associated with the first UE. The first UE will interpret the C-RNTI #x sent on the PDCCH as its own identity only if that PDCCH is sent in a radio frame/subframe associated with the first UE. The second UE will not be looking for a PDCCH addressed to it during those times since the time division of these two UEs is mutually exclusive on the control channel

The network can enforce this time division quite easily, such as for example when assigning discontinuous reception DRX periods to these UEs. Other examples for implementing this time domain separation are detailed further below, such as the system frame number and subframe number satisfying certain criteria such as frame/subframe groupings where the different groups are associated with the different first and second UEs. Such frame/subframe groups can be configured together with the C-RNTI, at least at the time when the same C-RNTI is assigned to the later-coming UE.

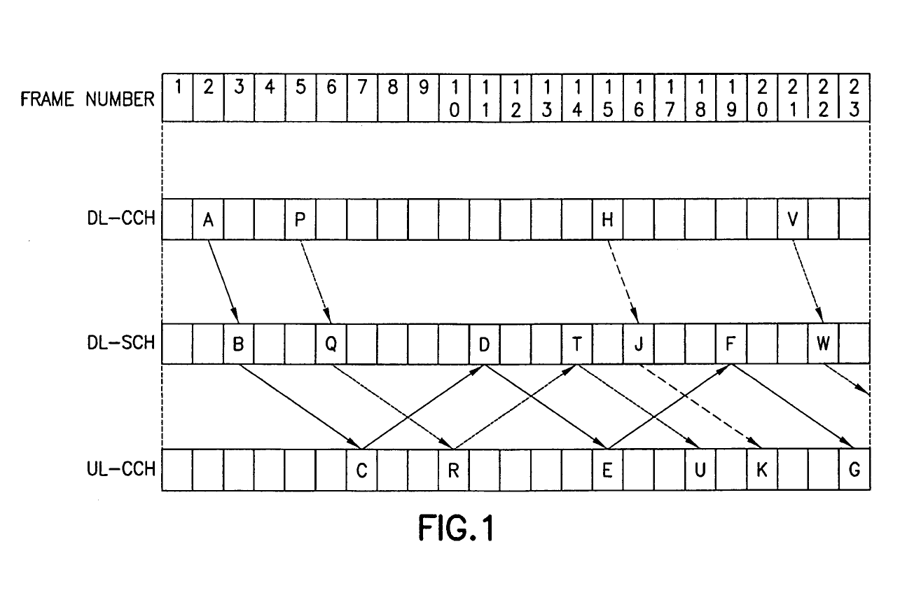

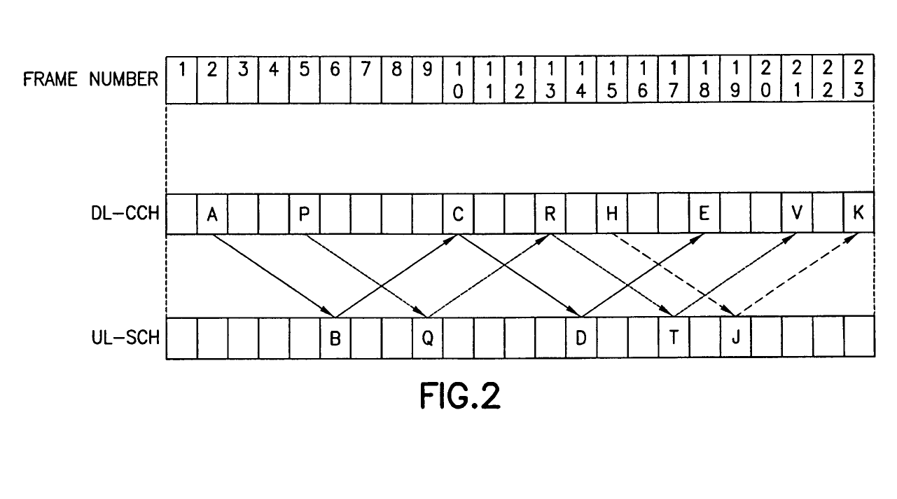

As a prelude to detailing the exemplary embodiments of the invention, FIGS. 1-2 detail a general relation among logical channels in a system in which channel or radio resource allocations on a shared channel are sent on a downlink control channel, and ACKs and NACKs for the data on the shared channel is sent also on a control channel. This general structure is present in E-UTRAN/LTE systems as well as others, and the high data throughput capacity of LTE indicates similar channel structures might be adopted in future systems also. Regardless of the specific radio access technology FIGS. 1-2 illustrate an exemplary environment in which embodiments of the invention may be practiced to advantage.

FIGS. 1 and 2 illustrate the logical DL-CCH and UL-CCH as independent channels although in the LTE system at least they are physically located on the same carriers with the data channels DL-SCH and UL-SCH. The names of the logical channels in FIGS. 1-2 can be mapped to corresponding channels in various radio access technology systems to show applicability of these teachings.

FIGS. 1-2 also have frame numbers recited linearly along the top of those drawings; other systems may use a hierarchical frame numbering system. For example, the radio frames of 10 ms are numbered linearly in FIGS. 1-2 but each radio frame may also include multiple subframes (e.g., 10 subframes indexed as 0 through 9 per radio frame in LTE). Other systems may use a different frame/slot/subframe numbering regimen to which FIGS. 1-2 may be reasonably adapted for implementations in other types of radio systems.

As noted above the DL-CCH is used for allocating the DL-SCH resources for a certain UE. The UE identifier is transmitted in some form on the DL-CCH to indicate the specific UE to which the allocation on the DL-SCH is granted. This is the UE's temporary cell identifier noted above. For example, the UE identifier may be transmitted explicitly in the DL-CCH, it may be encoded, the scheduling grant in the DL-CCH may be encrypted or otherwise encoded with a key which is the UE identifier or which is a function of the UE identifier, or the DL-CCH itself which is directed to the particular UE can be channel coded using the UE identifier as one of several coding parameters. There are many other options available, but the point is that the UE identifier is used in some manner so that only the UE to whom the DL-CCH is directed can read the relevant contents. More generally, the UE identifier is transmitted explicitly or implicitly in a specific frame of the DL-CCH.

In many cellular systems the UE identifier is assigned to the UE upon the UE becoming established in the cell, upon the UE becoming connected in a non-idle state, after a random access procedure, after a handover from an adjacent cell, or by other means. In any event it is the network which assigns the UE its temporary identifier for use in the cell.

Transmission of data according to FIG. 1 is conducted as follows. First the UE checks the DL-CCH sent by the network to check whether its identifier is transmitted in one of the frames. The reception of the DL-CCH may be discontinuous if the UE knows from its DRX configuration or from any other source that its identifier is not going to be transmitted in some frames. The UE identifier in LTE in this context is the C-RNTI.

When the UE detects its identifier and a channel allocation on the DL-CCH (point A in FIG. 1) it receives a piece of data on the DL-SCH according to the channel allocation information (point B). There may be a delay between A and B. Typically this delay is fixed in the radio system and may also be zero, that is the channel allocation and the data reception are in the same frame.

The UE then transmits an ACK or NACK on the UL-CCH depending on the success of the data reception. In the example in FIG. 1 the UE transmits a NACK after the first reception (point C) since it is assumed the data at point B was not properly received/decoded. This ACK or NACK usually happens at a fixed or preconfigured delay, so the network knows where to expect the UE feedback transmission. The ACK or NACK may also contain the UE identifier. The UE then receives on the DL-SCH retransmissions of the original data (at points D and F) until the data is received correctly (point F) at which point finally the UE transmits an ACK (point G).

In the above chain of transmissions no new channel allocations via the DL-CCH are needed in some systems such as LTE, because the NACKs (points C and E) implicitly act as an agreement that the same channel is used for the retransmissions at fixed or preconfigured delays. The retransmissions are usually implemented with HARQ, but different radio systems may use different retransmission methods and still take advantage of the teachings herein.

There may be several chains of data retransmissions present in parallel. FIG. 1 shows this in that the transmissions represented by PQRTU constitute one chain and the transmissions represented by HJK is another; and transmissions VW partially represent a third chain. The number of retransmissions varies. Note that for each transmission chain is initiated by a UE identifier and channel allocation message on the DL-CCH. These transmission chains are independent of each other and they may belong to the same UE or different UEs. The use of the channels for data transmission depends on the specific channel allocation procedures of the network and the radio access technology it employs.

FIG. 2 illustrates the operation of the uplink data transmission. Many of the principles used in the DL data transmissions continue in the UL data transmission chain and so only the differences are detailed for FIG. 2. In the case of FIG. 2 the DL-CCH (point A) allocates radio resources on the UL-SCH (point B). The delay between the network's transmission of the UE identifier and the channel allocation on the DL-CCH and the UE's data transmission on the allocated radio resource on the UL-SCH is typically longer. In LTE the reason for this is that the size of the transport block on the UL-SCH is not known before the UE receives the channel allocation on the DL-CCH, so the UE carries out the channel coding for the transmission only after receiving the channel allocation. The delays in general between these different logical channel transmissions are either fixed or preconfigured in the radio system.

The feedback for retransmissions (points C and E) is sent on the DL-CCH, i.e. the same channel as the channel allocations (point A). Retransmission at point D which results in the ACK/NACK feedback at point E assumes the feedback from the network at point C was a NACK. Typically the network will transmit the UE identifier along with the NACK (point C) as well as with the ACK (point E) responses to the UE's UL data (points B and D respectively).

Another transmission chain in FIG. 2 have an UL allocation sent with the UE identifier at P, UL data sent at point Q, the network's NACK with the UE identifier at R, the UE's re-transmission of its data at T, and finally the network's ACK with the UE identifier at V. The remaining UL data transmission chain shows the UL channel allocation and UE identifier sent by the network at H, UL data sent by the UE at J, and the network's ACK along with the UE identifier at K.

In certain practical network implementations, FIGS. 1 and 2 are actually describing the same channels and they are laid over each other to form a single system. Both uplink and downlink channel allocations may be transmitted together to the UE if there is data waiting to be transmitted in both directions at the same time, but logically the uplink and downlink procedures may be considered as separate and logically independent.

In view of the interrelationships among logical channels for both UL and DL data transmissions as detailed for FIGS. 1 and 2, it is seen that the UE identifier (the C-RNTI in LTE) plays an important role in the transmission procedures. Without additional arrangements, each UE must have a unique identifier in the cell else the resource/channel allocations on the DL-CCH and feedback signaling on the DL-CCH or the UL-CCH (as the case may be) would be ambiguous.

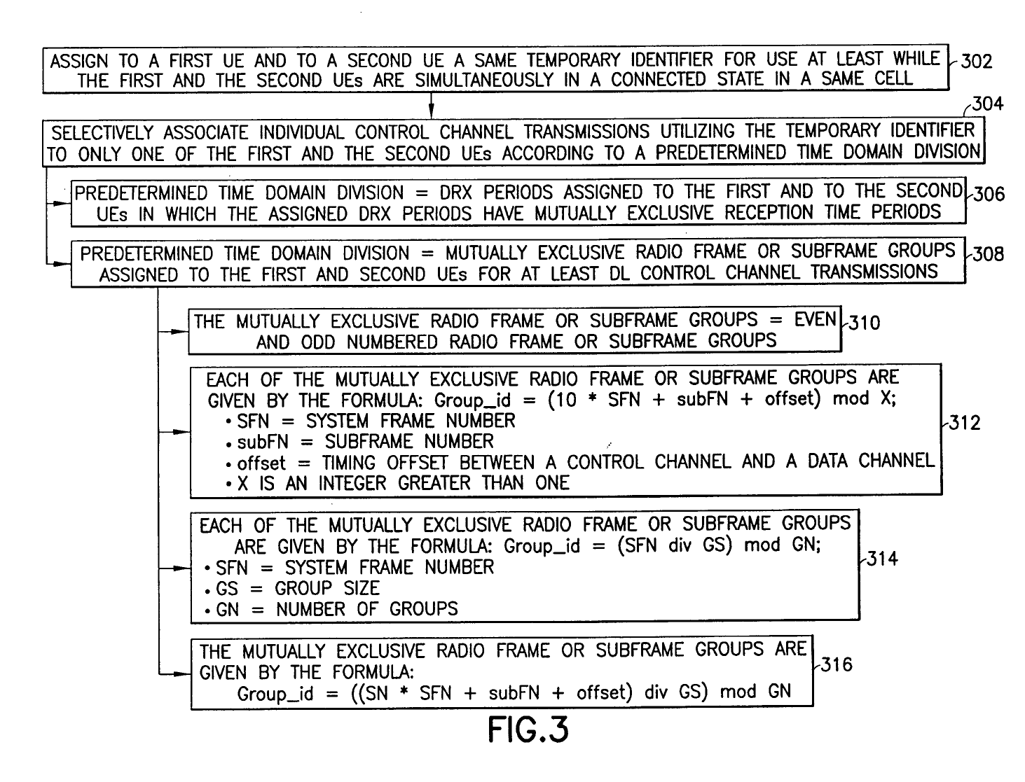

The number of unique identifiers which any given cell has for use among its UEs is usually limited and designed so that adjacent cells are not using the same ones. As noted in the background section above the radio environment is changing so that this limited number of UE identifiers per cell may become a limiting factor. Exemplary embodiments of these teachings provide a method to use the same UE identifier for more than one UE in a cell and still avoid the signaling of FIGS. 1-2 becoming ambiguous as to which UE such signaling is directed to or from which UE it originated. Below are also presented some variants of the core concepts as expanding but non-limiting examples with reference to FIG. 3.

Firstly, FIG. 3 begins with the broader aspects of these teachings as recited from the perspective of the network access node, such as an eNodeB operating in an E-UTRAN system having first and second UEs under its control. At block 302 the access node assigns to a first UE and to a second UE a same temporary identifier for use at least while the first and the second UEs are simultaneously in a connected state in a same cell. This does not imply that the UEs must be in a connected state at the time when the network first assigns these identifiers; only that the identifiers, once assigned, are for use while those UEs are in the connected state in the cell (and possibly also for use while they are in the idle state). At block 304 the access node then selectively associates individual control channel transmissions utilizing the temporary identifier to only one of the first and the second UEs according to a predetermined time domain division. The explicitly defined rules by which to do this may be stored in the eNodeB's local memory, and various examples are given below.

Various embodiments of the control channel transmissions ‘utilizing’ the identifier are given above, with both explicit and implicit utilizations detailed. Below are given various exemplary but non-limiting embodiments of how the eNodeB might enforce or otherwise purposefully bring about the predetermined time domain division so it can selectively associate different individual control channel transmissions (either or both of DL and UL control channel transmissions) with only one or the other of the first and second UEs.

At block 306 the predetermined time domain division comprises discontinuous reception DRX periods assigned to the first and to the second UEs in which those DRX periods have mutually exclusive reception time periods. In this manner while the first UE has a listening slot and checks the DL-CCH for its assigned (same) identifier the second UE is in a de-powered state to reduce its power consumption. Since the DRX periods are mutually exclusive in their reception time periods then when the second UE has an active listening slot the first UE is in a power saving mode and not listening on the DL-CCH.

The further examples at FIG. 3 have the predetermined time domain division as mutually exclusive radio frame or subframe groups assigned to the first and second UEs for at least DL control channel transmissions, as stated generally at block 308.

One particular embodiment of block 308 is detailed at block 310; the mutually exclusive radio frame or subframe groups are even and odd numbered radio frame or subframe groups. In this example there are only two UEs sharing the same temporary cell identifier so there only needs to be two groups, even and odd frames in this case (or equivalently even and odd subframes without regard to frame number). The first UE configured with the same identifier and odd frames/subframes would then use the identifier, but would be allowed to receive and transmit the identifier only in odd frames/subframes. The second UE can then use the same identifier, but only in the even frames/subframes. Note that both UEs could in principle use any frames in the UL-SCH and DL-SCH since those logical channels are not used to carry the identifier information, but the time domain restriction applies on the even or odd frames on the UL-CCH and the DL-CCH.

The grouping of the frame numbers could in practice use more complicated methods so that the same identifier can potentially be used with more than only two UEs. In principle any mathematical formula could be used to derive grouping of the frames and/or subframes, as long as the formula produce an unambiguous group identifier from the frame and/or subframe numbers. Said another way, the different grouping have mutually exclusive sets of either frames and/or of subframes. Different rules must usually be applied on different channels. Referring to FIG. 1, there is always a 5-frame offset between the channel allocation on the DL-CCH and the feedback on the UL-CCH. Therefore, an offset would typically be used, if the rules of the frame number grouping are done at the granularity of single frames.

As an example of this, the radio frames in LTE which are numbered with the SFN are divided into 10 subframes. The HARQ process cycle is 8 subframes. One way to conveniently to divide the subframes into 8 groups is with the formula:

Group_{—}id=(10*SFN+subFN+offset) mod 8.

In this formula SFN is the system frame number, subFN is the subframe number ranging between 0 . . . 9, and offset is the channel-specific offset that is needed to handle the timing differences of different channels in the manner noted above for the LTE system (or in a different manner for other systems). If instead there is needed only 4 or 2 groups the modulo operation can be changed from mod 8 to mod 4 or mod 2, respectively. This formula is particularly useful when the data rates are rather high and the delay requirements are stringent.

Block 312 of FIG. 3 gives a generic form of the above formula for generating such mutually exclusive groupings. Each of the mutually exclusive radio frame or subframe groups are given by the formula:

Group_{—}id=(10*SFN+subFN+offset) mod X;

in which SFN, subFN and offset are defined above and X is selected from the group 2, 4, and 8. These values for X provide the best performance, but other values of X can also be used so more generally X can be any integer greater than one.

This next example shows a coarser frame grouping and defines the groups by the following formula:

Group_{—}id=(SFN div GS) mod GN

In this formula SFN is again the system frame number, GS is the group size, and GN is the number of groups. Consider an example in which the frames of the system are 10 ms long, the GS value is set to 6 and the GN value is set to 10. The result would be a scheduling where each UE would have 60 ms active time in every 600 ms. The individual UE would be allowed to receive and transmit its ID during the active period only, which is mutually exclusive of the 60 ms active period of any of the other UEs (up to 9 others since GN=10) sharing this same UE identifier in the cell. This is shown at block 314 of FIG. 3.

Where completion of the (HARQ) re-transmission chain as detailed in FIGS. 1-2 requires the use of the UE identifier, the network must take this into account in the scheduling and not allocate the channel to any UE near the end of its active period, or potentially have to abort some re-transmission chain (which might be acceptable in certain circumstances or systems). The following formula for defining the frame and/or subframe groups alleviates this problem somewhat:

Group_{—}id=((SN*SFN+subFN+offset) div GS) mod GN

Meanings of these terms are all detailed above, and this formula is shown at block 316 of FIG. 3. This formula achieves the same configuration as above by setting GS=6*SN, GN=10, offset=0 for the DL-CCH and offset=−5 for the UL-CCH, assuming SN subframes in the radio frames which are numbered with the SFNs.

This variant is more advantageous in cases where the UEs sharing the same identifier are not anticipated to need urgent data transmission and the amount of data is low. It is also necessary that there are other UEs in the cell that are not configured with any frame division, because this embodiment does not use the shared channels efficiently. But this is a moderate requirement, because it is very probable that in a practical deployment the UEs using this frame division technique will constitute a minority in terms of data volumes although they might form the majority of UEs in the cell (e.g., those UEs consuming the cell's identifier pool which in LTE is the C-RNTI pool).

FIG. 3 detailed above is a logic flow diagram which describes the above exemplary embodiments of the invention from the perspective of the network access node. FIG. 3 represents results from executing a computer program or an implementing algorithm stored in the local memory of the access node, as well as illustrating the operation of a method and a specific manner in which the processor and memory with computer program/algorithm are configured to cause that access node (or one or more components thereof) to operate. The various blocks shown in FIG. 3 may also be considered as a plurality of coupled logic circuit elements constructed to carry out the associated function(s), or specific result or function of strings of computer program code stored in a computer readable memory.

Such blocks and the functions they represent are non-limiting examples, and may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

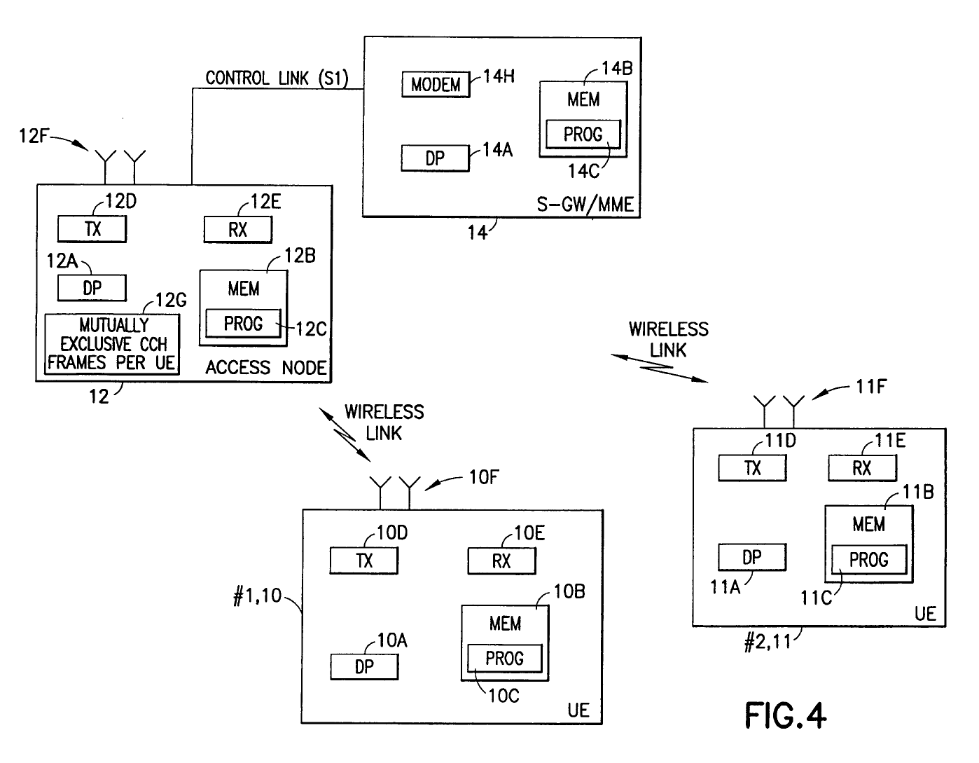

Reference is now made to FIG. 4 for illustrating a simplified block diagram of various electronic devices and apparatus that are suitable for use in practicing the exemplary embodiments of this invention. In FIG. 4 a serving cell or network access node 12 is adapted for communication over a wireless link with a mobile apparatus, such as a mobile terminal or UE 10. The macro cell 22 may be a macro eNodeB, a remote radio head or relay station, or other type of base station/cellular network access node.

The first UE 10 includes processing means such as at least one data processor (DP) 10A, storing means such as at least one computer-readable memory (MEM) 10B storing at least one computer program (PROG) 10C, and also communicating means such as a transmitter TX 10D and a receiver RX 10E for bidirectional wireless communications with the network access node 12 via one or more antennas 10F.

The network access node 12 similarly includes processing means such as at least one data processor (DP) 12A, storing means such as at least one computer-readable memory (MEM) 12B storing at least one computer program (PROG) 12C, and communicating means such as a transmitter TX 12D and a receiver RX 12E for bidirectional wireless communications with the UE 10 via one or more antennas 12F. There is a data and/or control path, termed at FIG. 4 as a control link which in the LTE system may be implemented as an S1 interface, coupling the network access node 12 with the serving gateway S-GW/mobility management entity MME 14 (or more generally a higher network node). The network access node 12 stores at 12G an association of each UE 10, 11 sharing a same temporary cell identifier with the radio frames or other time division means by which the access node uses to distinguish which control channel transmission is associated with which of those UEs 10, 11 as detailed above.

Similarly, the S-GW/MME 14 includes processing means such as at least one data processor (DP) 14A, storing means such as at least one computer-readable memory (MEM) 14B storing at least one computer program (PROG) 14C, and communicating means such as a modem 14H for bidirectional communication with the network access node 12 via the control link. While not particularly illustrated for the UE 10 or network access node 12, those devices are also assumed to include as part of their wireless communicating means a modem which may be inbuilt on a radiofrequency RF front end chip within those devices 10, 12 and which chip also carries the TX 10D/12D and the RX 10E/12E.

For completeness also is shown the second UE 11 which includes its own processing means such as at least one data processor (DP) 11A, storing means such as at least one computer-readable memory (MEM) 11B storing at least one computer program (PROG) 11C, and communicating means such as a transmitter TX 11D and a receiver RX 11E for bidirectional wireless communications with the access node 12 via one or more antennas 11F.

At least one of the PROGs 12C in the access node 12 is assumed to include program instructions that, when executed by the associated DP 12A, enable the device to operate in accordance with the exemplary embodiments of this invention, as detailed above. In this regard the exemplary embodiments of this invention may be implemented at least in part by computer software stored on the MEM 12B which is executable by the DP 12A of the access node 12, or by hardware, or by a combination of tangibly stored software and hardware (and tangibly stored firmware). Electronic devices implementing these aspects of the invention need not be the entire devices as depicted at FIG. 4, but exemplary embodiments may be implemented by one or more components of same such as the above described tangibly stored software, hardware, firmware and DP, or a system on a chip SOC or an application specific integrated circuit ASIC.

Various embodiments of the computer readable MEMs 10B, 11B, 12B and 14B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 10A, 11A, 12A and 14A include but are not limited to general purpose computers, special purpose computers, microprocessors, digital signal processors (DSPs) and multi-core processors.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

1. An apparatus, comprising:
a processing system comprising at least one processor, and a memory storing a set of computer instructions;
in which the processing system is arranged to:
assign to a first user equipment and to a second user equipment a same temporary identifier for use at least while the first and the second user equipments are simultaneously in a connected state in a same cell; and
selectively associate individual control channel transmissions utilizing the temporary identifier to only one of the first and the second user equipments according to a predetermined time domain division.

2. The apparatus according to claim 1, in which the predetermined time domain division comprises discontinuous reception periods assigned to the first and to the second user equipments which have mutually exclusive reception time periods.

3. The apparatus according to claim 1, in which the predetermined time domain division comprises mutually exclusive radio frame or subframe groups assigned to the first and second user equipments for at least downlink control channel transmissions.

4. The apparatus according to claim 3, in which the mutually exclusive radio frame or subframe groups are even and odd numbered radio frame or subframe groups.

5. The apparatus according to claim 3, in which each of the mutually exclusive radio frame or subframe groups are given by the formula:
Group_{—}id=(10*SFN+subFN+offset) mod X;
in which SFN is a system frame number; subFN is a subframe number; offset is a timing offset between a control channel and a data channel; and X is an integer greater than one.

6. The apparatus according to claim 3, in which each of the mutually exclusive radio frame or subframe groups are given by the formula:
Group_{—}id=(SFN div GS) mod GN;
in which SFN is a system frame number; GS is a group size; and GN is a number of groups.

7. The apparatus according to claim 3, in which each of the mutually exclusive radio frame or subframe groups are given by the formula:
Group_{—}id=((SN*SFN+subFN+offset) div GS) mod GN;
in which SFN is a system frame number; subFN is a subframe number; offset is a timing offset between a control channel and a data channel; GS is a group size; and GN is a number of groups.

8. The apparatus according to claim 1, in which the apparatus comprises a network access node.

9. The apparatus according to claim 8, in which the network access node comprises an eNodeB operating in an E-UTRAN system and the same temporary identifier is a same C-RNTI.

10. A method, comprising:
assigning to a first user equipment and to a second user equipment a same temporary identifier for use at least while the first and the second user equipments are simultaneously in a connected state in a same cell; and
selectively associating individual control channel transmissions utilizing the temporary identifier to only one of the first and the second user equipments according to a predetermined time domain division.

11. The method according to claim 10, in which the predetermined time domain division comprises mutually exclusive radio frame or subframe groups assigned to the first and second user equipments for at least downlink control channel transmissions.

12. The method according to claim 11, in which the mutually exclusive radio frame or subframe groups are even and odd numbered radio frame or subframe groups.

13. The method according to claim 11, in which each of the mutually exclusive radio frame or subframe groups are given by the formula:
Group_{—}id=(10*SFN+subFN+offset) mod X;
in which SFN is a system frame number; subFN is a subframe number; offset is a timing offset between a control channel and a data channel; and X is an integer greater than one.

14. The method according to claim 11, in which each of the mutually exclusive radio frame or subframe groups are given by the formula:
Group_{—}id=(SFN div GS) mod GN;
in which SFN is a system frame number; GS is a group size; and GN is a number of groups.

15. The method according to claim 11, in which each of the mutually exclusive radio frame or subframe groups are given by the formula:
Group_{—}id=((SN*SFN+subFN+offset) div GS) mod GN;
in which SFN is a system frame number; subFN is a subframe number; offset is a timing offset between a control channel and a data channel; GS is a group size; and GN is a number of groups.

16. The method according to claim 10, in which the method is executed by a network access node.

17. A computer readable memory storing a computer program comprising:
code for assigning to a first user equipment and to a second user equipment a same temporary identifier for use at least while the first and the second user equipments are simultaneously in a connected state in a same cell; and
code for selectively associating individual control channel transmissions utilizing the temporary identifier to only one of the first and the second user equipments according to a predetermined time domain division.

18. The computer readable memory according to claim 17, in which the predetermined time domain division comprises mutually exclusive radio frame or subframe groups assigned to the first and second user equipments for at least downlink control channel transmissions.

19. The computer readable memory according to claim 18, in which the mutually exclusive radio frame or subframe groups are even and odd numbered radio frame or subframe groups.

20. The computer readable memory according to claim 18, in which each of the mutually exclusive radio frame or subframe groups are given by one of:
the formula Group_{—}id=(10*SFN+subFN+offset) mod X; or
the formula Group_{—}id=(SFN div GS) mod GN; or
the formula Group_{—}id=((SN*SFN+subFN+offset) div GS) mod GN;
in which SFN is a system frame number; subFN is a subframe number; offset is a timing offset between a control channel and a data channel; X is an integer greater than one; GS is a group size; and GN is a number of groups.
